(19) United States
(12) Patent Application Publication
(10) Pub. No.: US 2008/0167026 A1
(43) Pub. Date: Jul. 10, 2008

(54) Method for Processing Measurement Control Messages and Mobile Radio Communications Terminal

(75) Inventors: Michael Eckert, Braunschweig (DE); Bernd Kemmer, Eichenau (DE); Gerhard Koula, Kolbermoor (DE); Martin Wuschke, Meine (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/913,609

(22) PCT Filed: May 2, 2006
(86) PCT No.: PCT/DE06/00764

§ 371 Date: Mar. 11, 2008

(30) Foreign Application Priority Data
May 3, 2005 (DE) 10 2005 020 637.9

(51) Int. Cl. H04M 3/00

(52) U.S. Cl. 455/418; 455/435.1

(57) ABSTRACT

In the event that a criterion according to a measurement job for at least one mobile radio cell is fulfilled, at least one indication of the mobile radio cell is stored. Upon receipt of a new measurement control message, by means of which a change in the measurement instruction is ordered for at least one of the mobile radio cells, at least one of the stored indications of the mobile radio cells is deleted according to the second measurement control message.

The invention relates to a method for processing measurement control messages, and to a mobile radio communications terminal.

Within a UMTS mobile radio communications system (UMTS: Universal Mobile Telecommunications System), provision is made for a mobile radio communications terminal to carry out measurements and transmit information about the measurement results to the mobile radio access network, in order to carry out or to maintain various functions (see [1]).

In a control message, which according to UMTS is also referred to as a “Measurement Control”, message, and which is also referred to in the following text as a measurement control message, the mobile radio access network (Radio Access Network, RAN) can signal to the mobile radio communications terminal which measurement results and which periodicity should be used as the basis for transmitting a measurement report message (referred to, according to UMTS, as a “Measurement Report” message) to the mobile radio access network and, if appropriate, which measurement results should be included in the measurement report message. A measurement event is also referred to in the following text as an “Event”. When a measurement event such as this occurs, the mobile radio access network then normally receives the measurement results from the mobile radio communications terminals which it requires in order to carry out or to maintain various functions, for example maintenance of the notified quality of service for a mobile radio communications link, with the aid of a so-called handover.

As described above, measurement results are transmitted, and therefore reported, from the mobile radio communications terminal periodically, that is to say at defined, predetermined time intervals (the so-called “Periodic Reporting”) or on the occurrence of a specific event (the so-called “Event Triggered Reporting”) to the mobile radio access network. Furthermore, a combination of “Event Triggered Reporting” and “Periodic Reporting” is provided, in which, after the occurrence of a specific measurement event, a defined number of measurement results are transmitted (reported) at specific times to the mobile radio access network, using a measurement report message.

This relates, for example according to [1] to the Intra-Frequency Report Events 1A (a Primary CPICH (CPICH: Common Pilot Channel) achieves a specific value range) and to the intra-frequency report events 1C (a “non-active” Primary CPICH is better than an “active” Primary CPICH).

When, on the basis of the measurements, the conditions for the occurrence of an event are found for the first time, then, according to UMTS, a timer is started (“Time To Trigger” (TTT). When, after the time to trigger the event (“Time to Trigger”) has elapsed, the conditions have still been satisfied without any interruption, and still exist, the corresponding mobile radio cells are recorded in the so-called “Cells Recently Triggered” list, and this is reported to the mobile radio access network by means of a measurement report message. The statement relating to the mobile radio cell for which a measurement report message has been produced and has been transmitted to the mobile radio access network is then included in the so-called “Cells Triggered” list. In the case of “Event Triggered Periodic Reporting” and in the case of “Periodic Reporting”, measurements are then reported, that is to say transmitted, at specific times, that is to say after in each case one reporting interval has elapsed, in further measurement report messages to the mobile radio access network.

When a measurement order to a mobile radio communications terminal is modified on the basis of a new measurement control message from the mobile radio access network, before a measurement report message for the old measurement order has been sent, it is possible for the parameters in the measurement order (that is to say the Event Description (Event Description), for example the Cell Information (Cell Information), the Measurement Quantity (Measurement Quantity), the event identification statement (Event Identity) to change and/or for new mobile radio cells to be added to the measurement order, or for existing mobile radio cells to be deleted from this measurement order. In this case, it is possible for the mobile radio cells or values which have already been stored in the “Cells Recently Triggered” or “Cells Triggered” file at this time to no longer be of any interest to the mobile radio access network, because they relate to the old configuration of the measurement order.

Document [2] describes a method for management of a virtual set of cells. The virtual set of cells is formed on the basis of a measurement control message.

The document [3] describes a communications terminal which uses an active set of base stations at a first frequency, and manages a virtual active set of base stations at a second frequency, and switches to the virtual active set on the basis of frequency measurements.

The document [4] describes an apparatus in a mobile communications system having a control device which categorizes a plurality of cells into a plurality of sets, with the sets being associated with different measurements.

The document [5] discloses a method in which parameter values which describe the radio link between a mobile terminal and a stationary transceiver are measured and are transmitted to a radio network control unit in the form of report messages. Furthermore, the speed of movement of the mobile terminal is estimated, and a report mode for the report messages is selected on the basis of this estimate and the parameter values.

The invention is based on the problem of specifying a method for processing measurement control messages as well as a mobile radio communications terminal which solves the problems as described above, in a simple manner.

The problem is solved by a method for processing measurement control messages, carried out by a mobile radio communications terminal, as well as by a mobile radio communications terminal having the features according to the independent patent claims.

In a method for processing measurement control messages, carried out by a mobile radio communications terminal, a check is carried out, for example continuously or continually, after the reception of a first measurement control message, to determine whether a criterion which is predetermined for the production of a measurement report message is satisfied, according to the first measurement control message, for at least one mobile radio cell. For the situation in which the criterion is satisfied for at least one mobile radio cell, at least one statement relating to the mobile radio cell is stored. In response to the reception of a second measurement control message, by means of which a message instruction change is instructed for at least one of the mobile radio cells, at least one of the stored statements relating to the mobile radio cells is deleted or amended, as a function of the second measurement control message.

A mobile radio communications terminal has a receiver for reception of message control messages, as well as a test unit, which is designed such that, after reception of a first measurement control message, it checks, for example continuously or continually, whether a criterion which is predetermined for the production of a measurement report message, according to the first measurement control message, is satisfied for at least one mobile radio cell and such that, in the situation in which the criterion is satisfied for at least one mobile radio cell, it stores at least one statement relating to the mobile radio cell. Furthermore, the mobile radio communications terminal has a memory for storage of the at least one statement relating to the mobile radio cell. Furthermore, a processing unit is provided, and is designed such that in response to the reception of a second measurement control message by means of which a measurement instruction change is instructed for at least one of the mobile radio cells, it deletes or amends at least one of the stored statements relating to the mobile radio cells, as a function of the second measurement control message. One aspect of the invention can therefore clearly be seen, for example, in use in a UMTS mobile radio communications network, using the following procedure, with a first measurement control message being transmitted to the mobile radio communications terminal from the mobile radio access network. The measurement control message has measurement instructions/report instructions, that is to say statements relating to which parameters the mobile radio communications terminal should measure and, if appropriate, the manner in which (periodically and/or on an event-triggered basis, that is to say for example periodic reporting and/or event triggered reporting) the measurement report message or messages should be transmitted to the mobile radio access network.

The parameters of the measurement order may, for example, be an event description, the mobile radio cell information, the measurement quantity, and the event identity statement.

If the preconditions for occurrence of an event are satisfied, then statements relating to the event are stored, for example by entering the mobile radio cell in the “cells recently triggered” list (file). If appropriate, and depending on the instructions from the first measurement control message, a measurement report message is produced, for example with the event identity and, if appropriate, with measured values as the content, and is transmitted to the mobile radio access network. The mobile radio cell is then entered in the “Cells Triggered” list (file). If a second measurement control message is transmitted from the mobile radio access network to the mobile radio communications terminal, and if the second measurement control message contains changes to the parameters in the measurement order for one or more mobile radio cells, and/or new mobile radio cells are added to the measurement order, or existing mobile radio cells are deleted from this measurement order, then the mobile radio access network deletes, or amends in a predeterminable manner, at least that information which is effected by the changes, that is to say the information which is now no longer of any interest for the mobile radio access network, from the “Cells Recently Triggered” list (file) and/or from the “Cells Triggered” list (file).

The invention therefore clearly results in statements which have been transmitted via a mobile radio cell and have been stored but are no longer of interest for the mobile radio access network in terms of the measurement order from the second measurement control message, need no longer be transmitted via the air interface, thus resulting in a reduction in the bandwidth required for the air interface.

Furthermore, it should be noted that, when used in a UMTS mobile radio communications network or a GSM mobile radio communications network for example, the invention provides a solution in the situation described above which results in reliable operation and virtually real-time response of the mobile radio communications terminal in the event of a change to the measurement orders, after reception of a plurality of measurement control messages.

In this context, the expression virtually in real-time should be understood as meaning that the method also results in measurements being considered which have already been carried out or are carried out continuously, and need not be received again “from the start”.

Exemplary embodiments of the invention result from the dependent claims.

The embodiments of the invention relate both to the method for processing measurement control messages and to the mobile radio communications terminal.

In the situation in which the criterion for at least one mobile radio cell is satisfied, a measurement report message can be produced, and the mobile radio communications terminal can change to a measurement message production state for at least one mobile radio cell, before the second measurement control message is received.

One embodiment of the invention provides for at least the statement relating to the mobile radio cell to be stored in a mobile radio cell triggered file, for example in the “Cells Triggered” file in the case of UMTS.

It is also possible to provide for a plurality of statements relating to different mobile radio cells to be stored, in each case for the situation in which a criterion which is predetermined for a respective mobile radio cell is satisfied for that respective mobile radio cell.

Furthermore, one embodiment provides not only for the respectively “related” statements relating to the mobile radio cells for which a change to the measurement instruction has been made on the basis of the instructions contained in the second measurement control message, to be deleted, but for all of the stored statements relating to the mobile radio cells to be deleted in response to the reception of the second measurement control message.

In other words, this embodiment of the invention means that, in response to the second measurement control message, the stored files, for example the “Cells Recently Triggered” file and/or the “Cells Triggered” file are/is set up again in accordance with the measurement orders contained in the second measurement control message.

This procedure makes it possible to ensure, in a very simple and therefore cost-effective manner, the operation of a mobile radio communications terminal in the scenario as described above.

Another embodiment of the invention provides for all of the stored statements relating to those mobile radio cells for which a measurement instruction change has been instructed in the second measurement control message to be deleted or amended in response to the reception of the second measurement control message.

This embodiment means that measured values which have already been measured and can still be made use of are not deleted “blindly”, but only those which relate to mobile radio cells for which there is a measurement order change.

According to yet another embodiment of the invention, a check is carried out for the stored statements relating to the mobile radio cells to determine whether the stored information associated with them is still valid, taking into account the second measurement control message. The stored statements relating to those mobile radio cells for which the information is no longer valid are deleted or amended.

According to this embodiment of the invention, a check is carried out in even more detail as to which information items that have already been measured are actually no longer of interest for the mobile radio access network, and these are the only ones which are deleted or amended.

Another embodiment of the invention provides for the predetermined criterion to have to be satisfied for a predetermined time period (for example “Time to Trigger” (TTT)), before the statement relating to the mobile radio cell is stored.

The mobile radio communications network may be a third-generation or a subsequent-generation mobile radio communications network (fourth generation, fifth generation, . . . ), for example a GSM mobile radio communications network or a UMTS mobile radio communications network.

The exemplary embodiments of the invention will be explained in more detail in the following text, and are illustrated in the figures, in which:

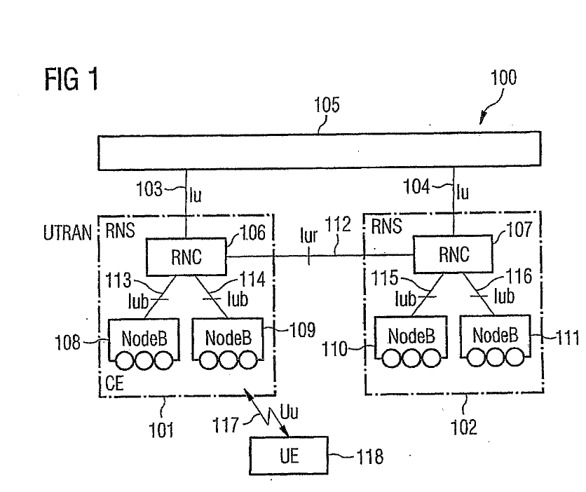

FIG. 1 shows a communications system according to one exemplary embodiment of the invention;

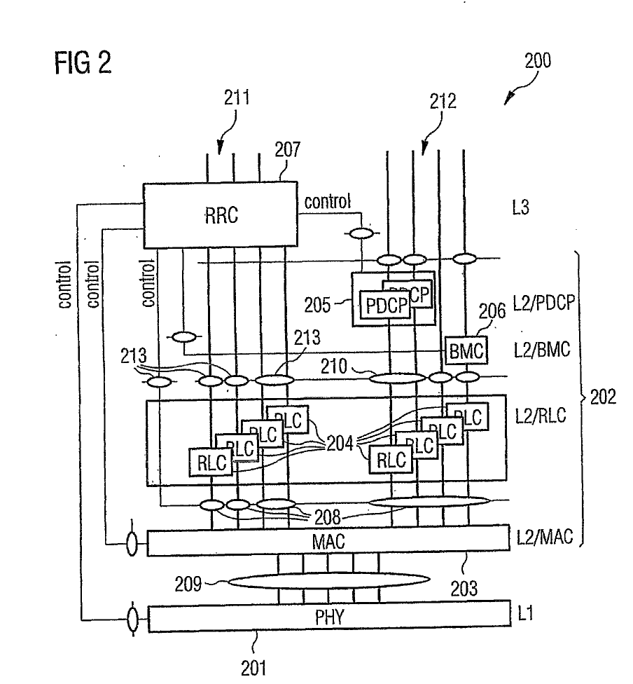

FIG. 2 shows an illustration of a protocol structure for the UMTS air interface;

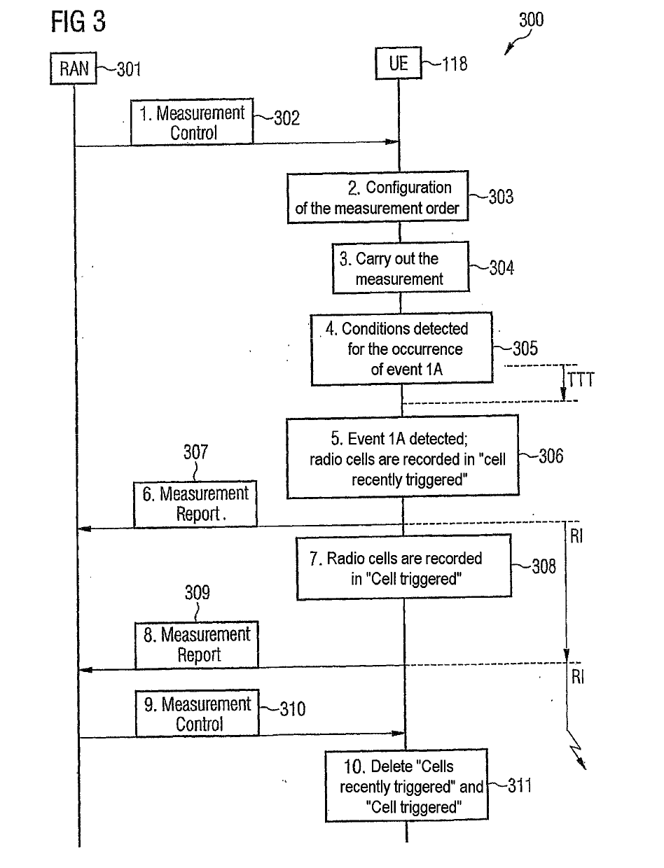

FIG. 3 shows a message flowchart, illustrating the individual method steps of a method, and the message interchange in the course of the method, according to one exemplary embodiment of the invention.

Even when the method is described in the following text with reference to a UMTS communications system, one alternative embodiment provides for it to be implemented, for example, in a GSM communications network, or alternatively in any other suitable communications network.

FIG. 1 illustrates a UMTS mobile radio system 100, for simplicity reasons, in particular the components of the UMTS mobile radio access network (UMTS Terrestrial Radio Access Network, UTRAN), which has a plurality of Mobile Radio Network Subsystems (RNS) 101, 102, each of which is connected by means of a so-called Iu interface 103, 104 to the UMTS Core Network (CN) 105. A mobile radio network subsystem 101, 102 has in each case one mobile radio network control unit (Radio Network Controller, RNC) 106, 107 as well as one or more UMTS base stations 108, 109, 110, 111, which are also referred to, in accordance with UMTS, as NodeB.

Within the mobile radio access network, the mobile radio network control units 106, 107 of the individual mobile radio network subsystems 101, 102 are connected to one another by means of a so-called Iur interface 112. Each mobile radio network control unit 106, 107 in each case monitors the association between the mobile radio resources of all the mobile radio cells in a mobile radio network subsystem 101, 102.

A UMTS base station 108, 109, 110, 111 is in each case connected by means of a so-called Iub interface 113, 114, 115, 116 to a mobile radio network control unit 106, 107 associated with that base station.

From the radio point of view, each UMTS base station 108, 109, 110, 111 obviously covers one or more mobile radio cells (CE) within a mobile radio network subsystem 101, 102. Message signals and/or data signals are transmitted by means of an air interface, referred to in accordance with UMTS as a Uu air interface 117, preferably using a multiple access transmission method, between a respective UMTS base station 108, 109, 110, 111 and a subscriber appliance 118 (User Equipment, UE), which is also referred to in the following text as a mobile radio communications terminal, in a mobile radio cell.

By way of example separate signal transmission is achieved by means of the UMTS FDD mode (Frequency Division Duplexing) in the uplink and downlink directions (Uplink: signal transmission from the mobile radio communications terminal 118 to the respective UMTS base station 108, 109, 110, 111; downlink: signal transmission from the respective associated UMTS base station 108, 109, 110, 111 to the mobile radio communications terminal 118) by means of appropriate separate assignment of frequencies or frequency ranges.

A plurality of subscribers, or in other words a plurality of activated mobile radio communications terminals 118, or mobile radio communications terminals 118 which are registered in that mobile radio access network, are preferably separated from one another for signaling purposes in the same mobile radio cell by means of orthogonal codes, in particular using the so-called CDMA method (Code Division Multiple Access).

In this context, it should be noted that, for simplicity reasons, FIG. 1 illustrates only one mobile radio communications terminal 118. In general, however, an undefined number of mobile radio communications terminals 118 are provided in the mobile radio system 100.

The communication between a mobile radio communications terminal 118 and another communications terminal can be set up by means of a complete mobile radio communications link to another mobile radio communications terminal, or alternatively to a landline communication appliance.

As is illustrated in FIG. 2, the UMTS air interface 117 is logically subdivided into three protocol layers (symbolized by a protocol layer arrangement 200 in FIG. 2). The units (entities) which ensure and provide the functionality of the respective protocol layers described in the following text are implemented not only in the mobile radio communications terminal 118 but also in the UMTS base station 108, 109, 110, 111 and in the respective mobile radio network control unit 106, 107.

FIG. 2 shows the protocol structure 200 from the point of view of the dedicated transport channel DCH.

The lowest layer illustrated in FIG. 2 is the physical layer PHY 201 which, in accordance with the OSI (Open System Interconnection) reference model, represents the protocol layer 1 in accordance with the ISO (International Standardization Organization).

The protocol layer arranged above the physical layer 201 is the data link layer 202, the protocol layer 2 in accordance with the OSI reference model, which itself has a plurality of protocol layer elements, specifically the medium access control protocol layer (MAC protocol layer) 203, the radio link control protocol layer 204 (RLC protocol layer), the packet data convergence protocol protocol layer 205 (PDCP protocol layer), and the broadcast/multicast control protocol layer 206 (BMC protocol layer).

The uppermost layer in the UMTS air interface Uu is the mobile radio network layer (the protocol layer 3 in accordance with the OSI reference model), including the mobile radio resource control unit 207 (Radio Resource Control protocol layer, RRC protocol layer).

Each protocol layer 201, 202, 203, 204, 205, 206, 207 offers its services to the protocol layer above it via predetermined, defined service access points.

The service access points are provided with generally conventional and unambiguous names, in order to allow better understanding of the protocol layer architecture, for example logical channels 208 between the MAC protocol layer 203 and the RLC protocol layer 204, transport channels 209 between the physical layer 201 and the MAC protocol layer 203, radio bearer (RB) 210 between the RLC protocol layer 204 and the PDCP protocol layer 205, and the BMC protocol layer 206, as well as the signaling radio bearer (SRB) 213 between the RLC protocol layer 204 and the RRC protocol layer 207.

In accordance with UMTS, the protocol structure 200 illustrated in FIG. 2 is not only split horizontally into the protocol layers and units of the respective protocol layers as described above, but is also split vertically into a so-called control protocol plane 211 (Control Plane, C-Plane), which contains parts of the physical layer 201, parts of the MAC protocol layer 203, parts of the RLC protocol layer 204 as well as the RRC protocol layer 207, and the user protocol plane 212 (User Plane, U-Plane), which contains parts of the physical layer 201, parts of the MAC protocol layer 203, parts of the RLC protocol layer 204, the PDCP protocol layer 205 as well as the BMC protocol layer 206.

Only control data which is required to set up and to clear, as well as to maintain, a communication link is transmitted by means of the entities in the control protocol plane 211, while in contrast the actual user data is transported by means of the entities in the user plane 212.

Every protocol layer and every entity in a respective protocol layer has specific predetermined functions for mobile radio communication purposes.

At the transmitter end, the function of the physical layer 201 and of the entities in the physical layer 201 is to ensure reliable transmission of data coming from the MAC protocol layer 203 via the air interface 117. In this context, the data is mapped onto physical channels (not illustrated in FIG. 2). The physical layer 201 offers its services to the MAC protocol layer 203 via transport channels 209, which are used to define how and with what characteristic the data should be transported via the air interface 117. The major functions which are provided by the entities in the physical layer 201 include channel coding, modulation and CDMA code spreading. In a corresponding manner, the physical layer 201 and the entities in the physical layer 201 at the receiver end carry out the CDMA code dispreading, the demodulation and the decoding of the received data, and then pass these onto the MAC protocol layer 203 for further processing.

The MAC protocol layer 203 and the entities in the MAC protocol layer 203 offer their services to the RLC protocol layer 204 by means of logical channels 208 as service access points, which are used to characterize the type of file the transported data represents. The task of the MAC protocol layer 203 in the transmitter, that is to say for data transmission in the uplink direction in the mobile radio communications terminal 118, is, in particular, to map the data which is present in a logical channel 208 above the MAC protocol layer 203 onto the transport channels 209 of the physical layer 201. For this purpose, the physical layer 201 offers discrete transmission rates for the transport channels 209. One important function of the MAC protocol layer 203 and of the entities in the MAC protocol layer 203 in the mobile radio communications terminal 118 during transmission is therefore the selection of a suitable transport format (TF) for every configured transport channel as a function of the respective data transmission rate at that time and of the respective data priority of the logical channels 208 which are mapped onto the respective transport channel 209, as well as the available transmission power of the mobile radio communications terminal 118 (UE). A transport format is used, inter alia, to define how many MAC data packet units, referred to as a transport block, are sent, or in other words transmitted, per transmission time interval TTI via the transport channel 209 to the physical layer 201. The permissible transport formats as well as the permissible combinations of transport formats of the various transport channels 209 are signaled to the mobile radio communications terminal 118 from the mobile radio network control unit 106, 107 when setting up a communication link. In the receiver, the entities in the MAC protocol layer 203 once again split the transport blocks received on the transport channels 209 between the logical channels 208.

The MAC protocol layer and the entities in the MAC protocol layer 203 normally have three logical entities. The so-called MAC-d unit (MAC dedicated entity) deals with the user data and the control data which is mapped via the corresponding dedicated logical channels DTCH (Dedicated Traffic Channel) and DCCH (Dedicated Control Channel) onto the dedicated transport channels DCH (Dedicated Channel). The MAC-c/sh entity (MAC control/shared entity) handles the user data and the control data of the logical channels 208, which are mapped onto the common transport channels 209, such as the common transport channel RACH (Random Access Channel) in the uplink direction, or the common transport channel FACH (Forward Access Channel) in the downlink direction. The MAC-b entity (MAC broadcast unit) handles only the mobile radio cell-relevant system information, which is mapped via the logical channel BCCH (Broadcast Control Channel) onto the transport channel BCH (Broadcast Channel) and is transmitted by broadcast to all the mobile radio communications terminals 118 in the respective mobile radio cell.

By means of the RLC protocol layer 204 and by means of the entities in the RLC protocol layer 204, the RLC protocol layer 207 is offered their services by means of signaling radio bearer (SRB) 213 as service access points, and the PDCP protocol layer 205 and the BMC protocol layer 206 by means of radio bearer (RB) 210 as service access points. The signaling radio bearer and the radio bearer characterize how the RRC protocol layer 204 has to handle the data packets. For this purpose, by way of example, the RRC protocol layer 207 defines the transmission mode for each configured signaling radio bearer or radio bearer. UMTS provides the following transmission modes:
Transparent Mode (TM),
Unacknowledged Mode (UM), or
Acknowledged Mode (AM).

The RLC protocol layer 204 is modeled such that there is one autonomous RLC entity per radio bearer or signaling radio bearer. Furthermore, the task of the RLC protocol layer and of its entities 204 in the transmission device is to split or to join the user data and the signaling data of radio bearers and signaling radio bearers in data packets. The RLC protocol layer 204 transfers the data packets that have been created after being split or joined together to the MAC protocol layer 203 for further transport, and/or for further processing.

Furthermore, a transmission security method is applied to the RLC protocol layer plane in order to ensure data transmission with as few errors as possible. However, this is provided only in the acknowledged transmission mode, that is to say for data transmission with reception confirmation. For this purpose, the RLC protocol data entities are numbered successively in the transmitter and are temporarily stored in an RLC buffer store until the appropriate confirmations of correct reception of the respective protocol data entity or entities is signaled by the receiver. If the transmitter does not receive any confirmation of correct reception, then the data packets received with errors are transmitted again. Transmission errors are identified in the receiver on the basis of gaps in the numerical sequence which, as has been described above, is allocated to the RLC protocol data entities. The receiver signals to the transmitter correct or incorrect reception of the data packets using so-called status protocol data entities, that is to say the RLC-specific control data entities. Two possible ways are provided for transmission of the RLC status protocol data entities. On the one hand, a separate control data entity is provided, and on the other hand a piggyback with the user data, that is to say packed in a user data protocol data packet, that is to say in a user data protocol data entity.

Furthermore, in this context, it should be noted that the transmission of this RLC control information normally has a higher priority than the user data packets.

The PDCP protocol layer 205 and the entities in the PDCP protocol layer 205 are designed for transmission and for reception of data in the so-called Packet Switched Domain (PS domain). The main function of the PDCP protocol layer 205 is compression and decompression of the IP header information (Internet Protocol Header Information).

The BMC protocol layer 206 and its entities are used in order to transmit and to receive so-called cell broadcast messages via the air interface.

The RRC protocol layer 207 and the entities in the RRC protocol layer 207 are responsible for setting up, clearing and reconfiguration of the physical channels, transport channels 209, logical channels 208, signaling radio bearers 213 and radio bearers 210, and for handling all the parameters in the protocol layer 1, that is to say the physical layer 201 and the protocol layer 2. For this purpose, the RRC entities, that is to say the entities in the RRC protocol layer 207 in the mobile radio network control unit 106, 107 and the respective mobile radio communications terminal 118, interchange appropriate RRC messages via the signaling radio bearers 213. Details relating to the RRC layer are described in [1].

As has been described above, the mobile radio communications terminal 118 can signal to the mobile radio network control unit 106, 107 associated with it information (the so-called measurement report messages) at the RRC level about the amount of data traffic on a transport channel, for the purpose of management of the mobile radio resources.

The serving mobile radio network control unit 106, 107 can then use this information to appropriately configure the mobile radio communications terminal 118 in order, for example, to restrict or to increase the useable transport formats of a mobile radio communications terminal 118, or to carry out a handover to another mobile radio cell, a reconfiguration of the dedicated physical channels, or an RRC state change from a first state (CELL_DCH) to a second state CELL_FACH.

The following text describes a method in more detail for modification of measurement orders in the mobile radio communications system UMTS for the situation in which a measurement order is amended by a measurement control message from the mobile radio access network (RAN) when values based on the old measurement order according to a previous measurement control message are already in the “Cells Recently Triggered” or “Cells Triggered”, or are stored in the respective files, and no measurement report message has yet been sent for the old measurement order to the mobile radio access network, or when the intention is to send further measurement report messages after transmission of one measurement report message.

According to a first variant, the “Cells Recently Triggered” file and “Cells Triggered” file in the mobile radio communications terminal 118 are completely deleted after reception of a “measurement control” message from the mobile radio access network, which amends the parameters of the measurement order (event description) and/or adds new mobile radio cells to the measurement order or removes existing mobile radio cells from this event description, since this can completely change the condition of the measurement order, and the mobile radio cells and values which are already located in the “Cells Recently Triggered” file or in the “Cells Triggered” file at this time, that is to say they are stored in these files, may no longer be of interest for the mobile radio access network because they relate to the configuration of the old measurement order on the basis of the original measurement control message description.

Furthermore, according to this exemplary embodiment of the invention, the “Time to Trigger” (TTT) timer is reset. The timer is started when the conditions for the occurrence of an event are detected for the first time on the basis of measurements. If, while the “Time to Trigger” is elapsing, these conditions were still to be valid without any interruption and were still valid, the corresponding mobile radio cells are recorded in the “Cells Recently Triggered” file, and this is reported to the mobile radio access network by means of a measurement report message. The mobile radio cells are then recorded in the “Cells Triggered” file. In the case of event triggered periodic reporting or periodic reporting, further measurement report messages are transmitted to the mobile radio access network at specific times, that is to say after the end of each predetermined time interval (also referred to as a “Reporting Interval”).

In a second embodiment of the invention, the “Cells Recently Triggered” file and the “Cells Triggered” file in the mobile radio communications terminal 118 are modified such that the mobile radio cells which have been deleted from the measurement order on the basis of the respectively more up to date measurement control message by the mobile radio access network, or the mobile radio cells whose parameters (event description) change on the basis of the more up to date measurement control message are deleted from the existing “Cells Recently Triggered” file or “Cells Triggered” file, or are amended. The other mobile radio cells which are stored in the “Cells Recently Triggered” file or in the “Cells Triggered” file remain unchanged, according to this embodiment of the invention.

According to a third refinement of the invention, all the mobile radio cells in the “Cells Recently Triggered” file or in the “Cells Triggered” file in the mobile radio communications terminal 118 are checked by the mobile radio access network after reception of an up-to-date measurement control message to determine whether the information is still valid. The only mobile radio cells which are then deleted from the “Cells Recently Triggered” file or from the “Cells Triggered” file are those which have been deleted from the measurement order, or those mobile radio cells which should no longer be contained in the “Cells Recently Triggered” file or in the “Cells Triggered” file on the basis of the new parameters (event description). The other mobile radio cells which have been entered in the “Cells Recently Triggered” file or in the “Cells Triggered” file also remain unaffected, in this embodiment of the invention.

Clearly, the methods described above specify a specific mobile radio communications terminal response for the situation in which measurement order which has not yet been processed by the respective mobile radio communications terminal is modified, for example by means of a more up to date measurement control message.

Without the methods described above, the mobile radio communications terminal response is unspecified, for example in accordance with UMTS or in accordance with GSM, which can lead to errors in signaling and data transmission between the mobile radio communications terminal and the mobile radio access network, and even to loss of the mobile radio communication link.

A new functionality of a UMTS mobile radio communications terminal and of a GSM mobile radio communications terminal for processing and modification of measurement orders is therefore clearly specified.

FIG. 3 uses a message flowchart 300 to show one of the variants of the invention as described above, in detail.

A mobile radio access network 301, designed in accordance with UMTS as a UTRAN (UMTS Terrestrial Radio Access Network) transmits a first measurement control message 302 to the mobile radio communications terminal 118. The first measurement control message 302 configures the mobile radio communications terminal 118 for an “intra-frequency measurement” measurement order.

After reception of the first measurement control message 302 in the mobile radio communications terminal 118, the latter configures the measurement order contained in the first measurement control message 302 (step 303).

The mobile radio communications terminal 118 then carries out the measurements in accordance with the measurement order using the measurement instructions contained in the first measurement control message 302, according to this exemplary embodiment of the invention with requested intra-frequency measurements (step 304).

The following text is based on the assumption that the conditions for the occurrence of the “Event 1A”, have occurred for one or more mobile radio cells as a result of appropriate determined measured values in the mobile radio communications terminal 118. The “Time to Trigger” (TTT) timer is therefore started for this respective measurement event (step 305).

Once the timer has timed out, that is to say after the time interval specified by the “Time to Trigger” (TTT) parameter has elapsed, and in the situation in which, after the time interval has elapsed, the stated conditions still exist and have done without any interruption, the “Event 1A” is regarded as having occurred. The corresponding mobile radio cells are recorded in the “Cells Recently Triggered” file in the mobile radio communications terminal 118 (Step 306).

The mobile radio communications terminal 118 then produces and transmits a first measurement report message 307 to the mobile radio access network 301, with the first measurement report message 307 containing at least the statement about the mobile radio cells for which the respective event has occurred in accordance with the measurement order. Provision is furthermore optionally made for an associated event identification statement (Event 1D), optionally as well as the determined measured values or some of the determined measured values, to be additionally stored for each event in the “Cells Recently Triggered” file or in the “Cells Triggered” file, and possibly also to be transmitted to the mobile radio access network in the measurement report message or messages.

After the measurement report message 307 has been transmitted, the corresponding mobile radio cells are recorded in the “Cells Triggered” file (step 308).

At specific times, that is to say on each occasion after a predetermined time interval has elapsed (also referred to as the “Reporting Interval”), further measurement report messages are produced, according to this exemplary embodiment after a time interval RI has elapsed, for example a second measurement report message 309 is produced by the mobile radio communications terminal 118, and is transmitted to the mobile radio access network 301. The mobile radio access network 301 produces a second measurement control message 310, and transmits it to the mobile radio communications terminal 118. The mobile radio access network 301 uses the second measurement control message 310 to amend the measurement order for the mobile radio communications terminal 118.

According to this exemplary embodiment of the invention, it is assumed that the “Time to Trigger” and the “Cell Information” parameters have been changed. It is also assumed that, as a result of these changes, the information in the “Cells Recently Triggered” file and in the “Cells Triggered” file is at least in some cases obsolete, and is no longer of interest for the mobile radio access network 301.

For this reason, in response to the reception of the second measurement control message 310 and after checking that the statements relating to the mobile radio cell in the “Cells Recently Triggered” file and/or the “Cells Triggered” file are no longer of interest for the mobile radio access network 301, the mobile radio communications terminal 118 deletes the “Cells Recently Triggered” and/or “Cells Triggered” file or files (step 311).

### LIST OF REFERENCE SYMBOLS

100 Mobile radio system
101 Mobile radio network subsystem
102 Mobile radio network subsystem
103 Iu Interface
104 Iu Interface
105 Mobile radio core network
106 Mobile radio network control unit
107 Mobile radio network control unit
108 UMTS base station
109 UMTS base station
111 UMTS base station
112 UMTS base station
113 Iur Interface
114 Iub Interface
115 Iub Interface
116 Iub Interface
117 Iub Interface
118 UU Interface
119 Mobile radio terminal
200 Protocol layer arrangement
201 Physical layer
202 Data link layer
203 MAC Protocol layer
204 RLC Protocol layer
205 PDCP Protocol layer
206 BMC Protocol layer
207 RRC Protocol layer
208 Logical channel
209 Transport channel
210 Radio bearer
211 Control plane
212 User plane
213 Signaling radio bearer
300 Message flowchart
301 Mobile radio access network
302 First measurement control message
303 Method step
304 Method step
305 Method step
306 Method step
307 First measurement report message
308 Method step
309 Second measurement report message
310 Second measurement control message
311 Method step

The following publication is cited in this document:
[1] 3GPP TS 25.331, Technical Specification, Third Generation Partnership Project; Technical Specification Group Radio Access Network; RRC Protocol Specification (Release 1999).
[2] US 2004/032845 A1
[3] WO 01/20942 A1
[4] US 2005/272425 A1
[5] US 2004/248568 A1

1-13. (canceled)

14. A method for processing measurement control messages, carried out by a mobile radio communications terminal, the method comprising:
carrying out a check, after reception of a first measurement control message, to determine whether a criterion which is predetermined for production of a measurement report message, according to the first measurement control message, is satisfied for at least one mobile radio cell;
when the criterion is satisfied for at least one mobile radio cell, storing at least one statement relating to the mobile radio cell; and
in response to reception of a second measurement control message, by means of which a measurement instruction change is instructed for at least one of the mobile radio cells, deleting or amending at least one of the stored statements relating to the mobile radio cells as a function of the second measurement control message.

15. The method as claimed in claim 14, further comprising:
when the criterion is satisfied for at least one mobile radio cell, producing a measurement report message,
wherein the mobile radio communications terminal changes to a measurement message production state for at least one mobile radio cell.

16. The method as claimed in claim 14, further comprising storing the statement relating to the mobile radio cell in a mobile radio cell triggered file.

17. The method as claimed in claim 14, further comprising storing a plurality of statements relating to different mobile radio cells, in each case when a criterion which is predetermined for a respective mobile radio cell is satisfied for that respective mobile radio cell.

18. The method as claimed in claim 14, further comprising deleting or amending, in response to the reception of the second measurement control message, all the stored statements relating to the mobile radio cells.

19. The method as claimed in claim 17, further comprising deleting or amending, in response to the reception of the second measurement control message, all of the stored statements relating to those mobile radio cells for which a measurement instruction change has been instructed in the second measurement control message.

20. The method as claimed in claim 17, further comprising:
carry out a check for the stored statements relating to the mobile radio cells to determine whether the stored information associated with them is still valid taking into account the second measurement control message; and
deleting or amending the stored statements relating to those mobile radio cells for which the information is no longer valid.

21. The method as claimed in claim 14, wherein the predetermined criterion must be satisfied for a predetermined time period before storing the statement relating to the mobile radio cell.

22. The method as claimed in claim 14, used in a third-generation or a subsequent-generation mobile radio communications network.

23. The method as claimed in claim 14, used in a GSM mobile radio communications network or in a UMTS mobile radio communications network.

24. A mobile radio communications terminal, comprising:
a receiver configured to receive measurement control messages;
a test unit configured to, after reception of a first measurement control message, check whether a criterion which is predetermined for production of a measurement report message, according to the first measurement control message, is satisfied for at least one mobile radio cell and, when the criterion is satisfied for at least one mobile radio cell, store at least one statement relating to the mobile radio cell;
a memory configured to store the at least one statement relating to the mobile radio cell; and
a processing unit configured to, in response to the reception of a second measurement control message by means of which a measurement instruction change is instructed for at least one of the mobile radio cells, delete at least one of the stored statements relating to the mobile radio cells, as a function of the second measurement control message.

25. The mobile radio communications terminal as claimed in claim 24, configured as a third-generation or a subsequent-generation mobile radio communications terminal.

26. The mobile radio communications terminal as claimed in claim 24, configured as a GSM mobile radio communications terminal or as a UMTS mobile radio communications terminal.

27. A mobile radio communications terminal, comprising:
a receiver means for receiving measurement control messages;
a test means for, after reception of a first measurement control message, checking whether a criterion which is predetermined for production of a measurement report message, according to the first measurement control message, is satisfied for at least one mobile radio cell and, when the criterion is satisfied for at least one mobile radio cell, storing at least one statement relating to the mobile radio cell;
a memory means for storing the at least one statement relating to the mobile radio cell; and
a processing means for, in response to the reception of a second measurement control message by means of which a measurement instruction change is instructed for at least one of the mobile radio cells, deleting at least one of the stored statements relating to the mobile radio cells, as a function of the second measurement control message.
